(19) United States
(12) Patent Application Publication
(10) Pub. No.: US 2015/0344379 A1
(43) Pub. Date: Dec. 3, 2015

(54) FISH PROCESSING METHOD

(71) Applicant: Takashi OHKUBO, Saga (JP)

(72) Inventor: Takashi OHKUBO, Saga (JP)

(21) Appl. No.: 14/437,845

(22) PCT Filed: Apr. 15, 2013
(86) PCT No.: PCT/JP2013/061208

§ 371 Date: Jul. 22, 2015

(30) Foreign Application Priority Data
Oct. 26, 2012 (JP) 2012-236318
Dec. 26, 2012 (JP) 2012-282144

(51) Int. Cl. C05F 1/00; C05B 17/00; A22C 25/00

(52) U.S. Cl. CPC C05F 1/002; A22C 25/00; C05B 17/00

(57) ABSTRACT

A fish processing method includes a salting step of putting salt on fish parts on a plate and leaving the fish parts with salt on the plate; and a drying step of hanging or placing the fish parts with salt on a net without exposing directly to sunlight and placing the fish parts so that oil is dripped from the fish parts with salt and evaporates right below the fish parts to surround the fish parts.

### BACKGROUND OF THE INVENTION AND RELATED ART STATEMENT

The present invention relates to a fish processing method.

Conventionally, a fish meat is served for eating while fish carcass (portions left after carving meat such as a head, a skin, scales, collars, bones, and fins) are discarded.

Especially, in case of poisonous globefish such as tiger puffer (Takifugu niphobles) and grass puffer (Takifugu rubripes), a certain poison (mainly tetrodotoxin) is accumulated in internal organs thereof. Therefore, is necessary to remove the internal organs before being served for eating the fish meat, and the internal organs are discarded (see Patent Reference, for example).

Patent Reference: Japanese Patent Application Publication No. 2008-241423

An object of the present invention is to provide a fish processing method, so as to effectively use a fish carcass, which is conventionally discarded, as a fertilizer, a livestock feed, or the like.

Further objects and advantages of the present invention will be apparent from the following description of the present invention.

### SUMMARY OF THE PRESENT INVENTION

In order to attain the objects described above, according to a first aspect of the present invention, a fish processing method includes a salting step of putting salt on fish parts on a plate and leaving the fish parts with salt on the plate; and a drying step of hanging or placing the fish parts with salt on a net without exposing directly to sunlight and placing the fish parts so that oil is dripped from the fish parts with salt and evaporates right below the fish parts to surround the fish parts.

According to a second aspect of the present invention, a fish carcass is obtained as the fish parts to be processed through carving a meat from a fish. After the drying step, the fish carcass is wrapped with an air-permeable sheet and left to stand. Then, the fish carcass is processed to produce a fertilizer containing nitrogen, phosphor, and potassium.

According to a third aspect of the present invention, a fish carcass is obtained as the fish parts to be processed through carving a meat from a fish. After the drying step, the fish carcass is placed on a non-air-permeable tray and left to stand. Then, the fish carcass is processed to produce a fertilizer containing an unsaturated fatty acid.

According to a fourth aspect of the present invention, internal organs of globefish are used as the fish parts to be processed. In the drying step, the internal organs of globefish are placed in a dark place where there is no direct sunlight at all, so as to eliminate toxicity of globefish.

According to the first aspect of the present invention, the method of processing the fish includes the salting step of putting salt on fish parts on a plate and leaving the fish parts with salt on the plate; and a drying step of hanging or placing the fish parts with salt on a net without exposing directly to sunlight and placing the fish parts so that oil is dripped from the fish parts with salt and evaporates right below the fish parts to surround the fish parts. Accordingly, it is possible to satisfactorily process the fish parts without spoiling the fish parts.

According to the second aspect of the present invention, fish carcass is obtained as the fish parts to be processed through carving a meat from the fish. After the drying step, the fish carcass is wrapped with the air-permeable sheet and left to stand. Then, the fish carcass is processed to produce a fertilizer containing nitrogen, phosphor, and potassium. Accordingly, it is possible to effectively use the fish carcass.

According to a third aspect of the present invention, a fish carcass is obtained as the fish parts to be processed through carving a meat from the fish. After the drying step, the fish carcass is placed on a non-air-permeable tray and left to stand. Then, the fish carcass is processed to produce a fertilizer containing an unsaturated fatty acid. Accordingly, it is possible to effectively use the fish carcass.

According to a fourth aspect of the present invention, internal organs of globefish are used as the fish parts to be processed. In the drying step, the internal organs of globefish are placed in a dark place where there is no direct sunlight at all, so as to eliminate toxicity of globefish. As a result, it is possible to effectively use the poisonous internal organs of globefish, which are conventionally wasted, as a raw material of processed good.

### BRIEF DESCRIPTION OF THE DRAWINGS

FIG. 1 shows test results from chemical analysis (for fertilizer use);

FIG. 2 shows test results from chemical analysis (for livestock feed use);

FIG. 3 shows test results from chemical analysis (lactic acid bacteria);

FIG. 4 shows test results from chemical analysis (vegetable);

FIG. 5 shows test results from chemical analysis (for comparison);

FIG. 6 shows test results from chemical analysis (grass puffer); and

FIG. 7 shows test results from chemical analysis (brown-backed toadfish)

### DETAILED DESCRIPTION OF THE PREFERRED EMBODIMENTS

Hereunder, detailed configuration of the present invention will be described.

According to the present invention, a fish processing method includes a salting step and a drying step.

In the salting step, fish parts are salted and left to stand as is for at least one day or about a week (preferably a week). In this salting step, the fish parts are sterilized with the salt and moisture in the fish is replaced with the salt. As a result, the fish parts are subjected to a dehydration process.

Here, as the fish parts, it is possible to use every sort of fish meat or fish carcass (fish parts left after carving meat, such as head, skin, scales, collars (parts under gill covers), fins, and guts). Such fish parts are not limited to the ones separated from other parts, but can be fish that only guts are removed therefrom.

In the drying step, the fish parts after the salting step are hanged (or placed on a net) while keeping the salt adhered thereon and without letting them be exposed to direct sunlight. As a result, oil dripped from the fish parts evaporates right under the fish parts and covers the fish parts, while leaving them to stand for a longer period of time than that of the salting step, e.g., at least more than one week or about one month (preferably one month). In this drying step, with action of the salt, it is possible to satisfactorily let the moisture and the oil contained in the fish drip (discharge). In addition, it is also possible to prevent bacteria growth and pest contamination with action of the oil dripped right under the fish parts.

Here, in the drying step, placing a reservoir right under the fish parts being hanged, the oil and the water dripped from the fish parts will be pooled therein. The supernatant of the fluid in the reservoir, i.e., oil, becomes selectively evaporated at room temperature, and the evaporated oil moves up to around the fish parts right above the reservoir and surrounds them. This drying step is preferably performed indoor, so as not to have the fish parts be exposed to direct sunlight, without ventilation. The fish parts may be wrapped with a sheet or other material that has breathability and water permeability. The fish parts after the drying step may be served as is for eating. Alternatively, it is also possible to serve the fish parts after the drying step may be subjected to a natural aging step by leaving the fish parts to stand for a longer period than that of the drying step, for example more than one month or about one year (preferably one year). After that the aged fish parts may be served as a food material, a fertilizer, or a livestock feed.

As a result, according to the present invention, it is possible to satisfactorily process (dry) fish/fish parts without spoiling. Moreover, the processed fish parts can be effectively used as a food material, a fertilizer, a livestock feed, or the like.

For example, according to the present invention, it is possible to satisfactorily process fish carcass (parts left after carving fish meat, such as head, skin, scales, collars, bones, fins, and guts) to make processed fish. In addition, it is further possible to produce a fertilizer, a livestock feed, or the like containing the processed fish.

In other words, according to the present invention, fish carcass left after carving fish meat is salted and left to stand as is for a certain time period. Thereafter, the fish carcass is hanged or placed on a net, while being in the salted state under natural environment, so as to be subjected to repetitive temperature changes, while avoiding exposure to direct sunlight, for a certain time period. As a result, it is possible to produce processed fish to serve as food, a fertilizer, or a livestock feed.

For the fish to use herein, for example, Japanese amberjack or yellowtail amberjack may be used. While fish is fresh without freezing, meat is removed from the fish (carcass preparation step).

Thereafter, the fish body left after carving the meat in the carcass preparation step is dismantled into parts, i.e., head, skin, scales, collars, bones, fins, and guts (dismantling process).

Here, the carcass preparation step and the dismantling step may be separately performed. More specifically, it is possible to dismantle fish parts after the carcass preparation step (removing only meat from the fish) as described above. Alternatively, it is also possible to perform the carcass preparation step and the dismantling step at once, by removing meat while dismantling the fish into meat, head, skin, scales, collars, fins, and guts. Moreover, fish carcass produced from factories that process fish to serve for eating may be also used.

Next, each fish carcass obtained from the precedent dismantling step is placed in powdered salt so as to cover the surface with salt (salting preparation step).

Then, while keeping the fish carcass salted as in the salting preparation step, the fish carcass is left to stand for a certain time period, at least one day or about a week (preferably one week) (salting step).

Applying salt over the surfaces of the fish carcass obtained from the dismantling step, it is possible to satisfactorily disinfecting the fish carcass and to prevent bacteria growth therein.

After that, the fish carcass after the salting step is hanged in natural environment where temperature repeatedly changes, while keeping the salt on their surfaces. For example, the fish carcass may be hanged or placed on a net in a mountain where naturally woods grow, avoiding direct sunlight, so as to leave to stand for a certain time period, at least one week or about one month (preferably one month) (drying step).

Here, in the drying step, the fish carcass with the salt adhered on its surface is wrapped with a sheet such as fabric, which has water permeability and finer mesh size than particle sizes of the powdered salt.

Thereafter, the fish carcass is left to stand during a length of time period to be subjected to repeated temperature changes, for example, for at least one month or about one year (preferably one year) (natural aging step). At this time, the fish carcass is left to stand so as to be covered with the oil that is dripped from the fish carcass and evaporated right under the fish parts to surround the fish carcass.

As a result, leaving the fish carcass hanged while being coated with the salt on the surface, it is possible to satisfactorily have the moisture and/or oil contained in the fish carcass be dripped (discharged). Moreover, the fish carcass is left to stand for a length of time period so as to be subjected to temperature changes in natural environment where temperature changes repeatedly occur. Therefore, lactic acid bacteria being resistant against salt under the natural environment propagate by the temperature exchange, and make the fish carcass be processed to contain lactic acid bacteria. Especially when the fish carcass is wrapped with a water-permeable sheet and then left to stand, it is possible to prevent the salt from falling (discharging) from the surfaces, and also to prevent losing (discharging) nutrients (nitrogen, phosphor, potassium, unsaturated fatty acid, lactic acid, etc.) with moisture and oil therefrom. Here, placing a reservoir to hold water and oil contents dripped from the fish carcass hanged right thereabove, it is possible to prevent bacterial growth and pest contamination.

The resultant processed fish can be served for eating as is, or may be used as a raw material of a fertilizer or a livestock feed.

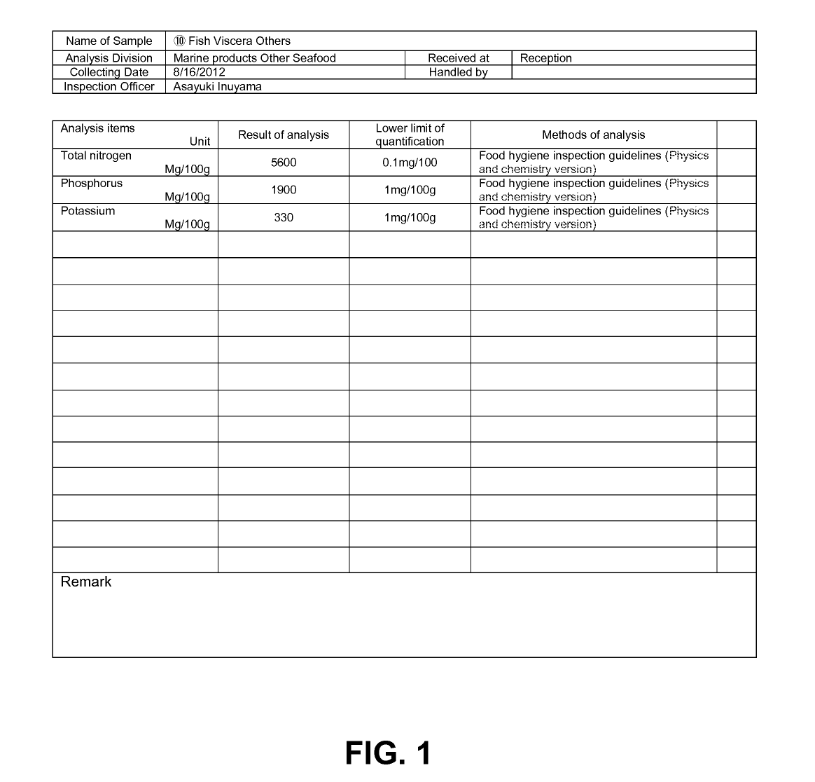

For example, in the natural aging step, the fish carcass after the drying step may be wrapped with a air-permeable sheet such as a palm husk and then left to stand. As a result, it is possible to produce a fertilizer containing nitrogen, phosphor, and potassium (see FIG. 1).

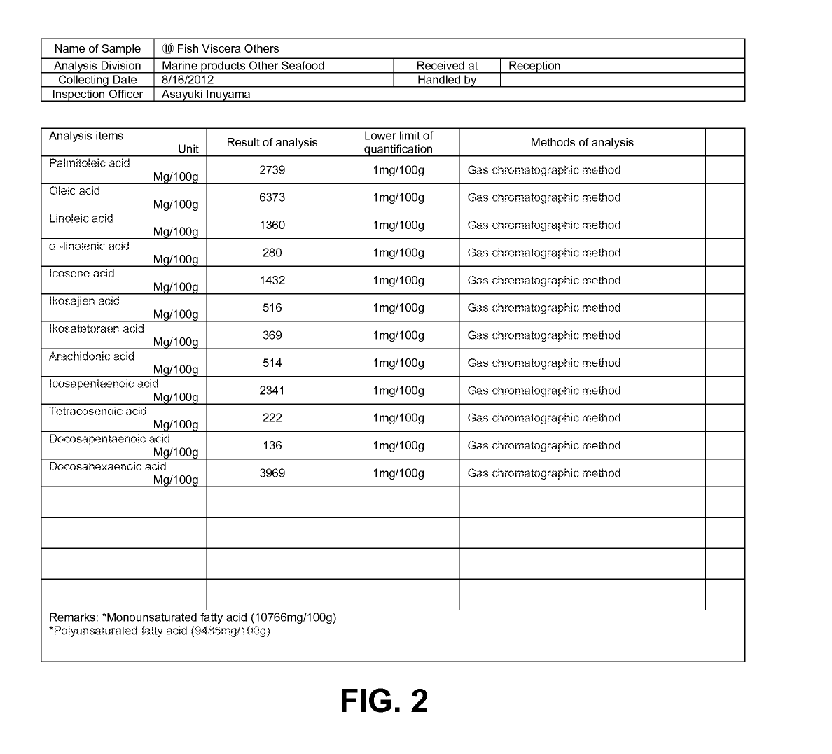

In addition, in the natural aging step, the fish carcass in the drying step can be placed on a non-water-permeable tray and then left to stand. As a result, it is possible to produce a livestock feed that contains unsaturated fatty acid (see FIG. 2). Here, the fish carcass may be shredded to be minced.

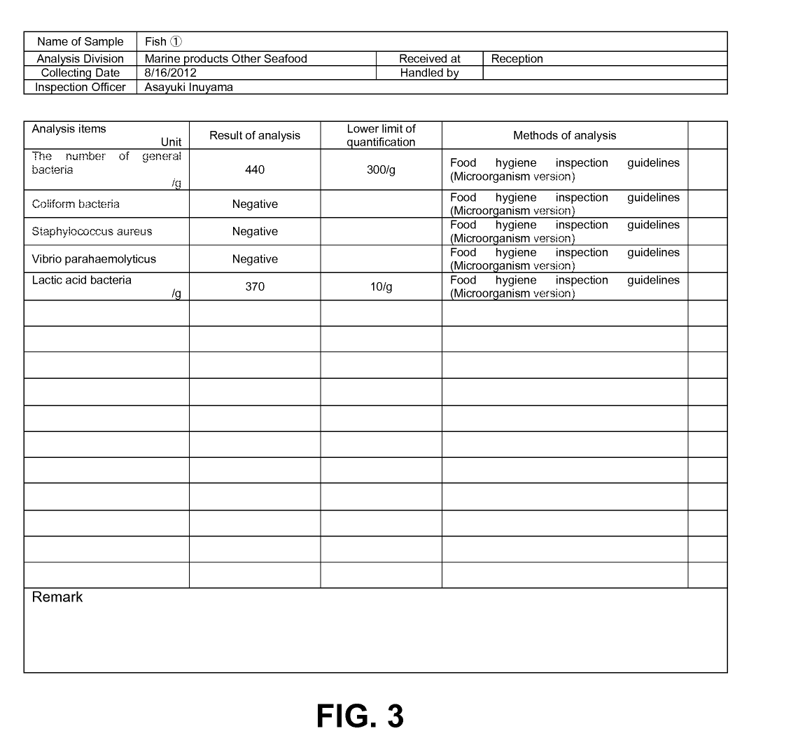

As an example, in case of processed fish, which was subjected to one week of the salting step and one year of the drying step, the analytical results show that it contained a large amount of nutrients, 5,600 mg/100 g of nitrogen, 1,900 mg/100 g of phosphor, and 330 mg/100 g of potassium as shown in FIG. 1. In addition, the analytical results show that it contained a large amount of livestock feed contents, 2,739 mg/100 g of palmitoleic acid, 6,373 mg/100 g of oleic acid, 1,432 mg/100 g of eicosenoic acid, 222 mg/100 g of tetracosenoic acid (1,076 mg/100 g of monovalent unsaturated fatty acid), 1,360 mg/100 g of linoleic acid, 280 mg/100 g of α-linolenic acid, 516 mg/100 g of eicosadienoic acid, 369 mg/100 g of eicosatetraenoic acid, 514 mg/100 g of arachidonic acid, 2,341 mg/100 g of eicosapentaenoic acid, 136 mg/100 g of docosapentaenoic acid, 3,969 mg/100 g of docosahexaenoic acid (9,485 mg/100 g of polyvalent unsaturated fatty acid) as shown in FIG. 2. In addition, growth of lactic acid bacteria (370 pieces/g) was confirmed as shown in FIG. 3

From those results, it was confirmed that it is possible to effectively use the processed fish as a raw material of a fertilizer or a livestock feed.

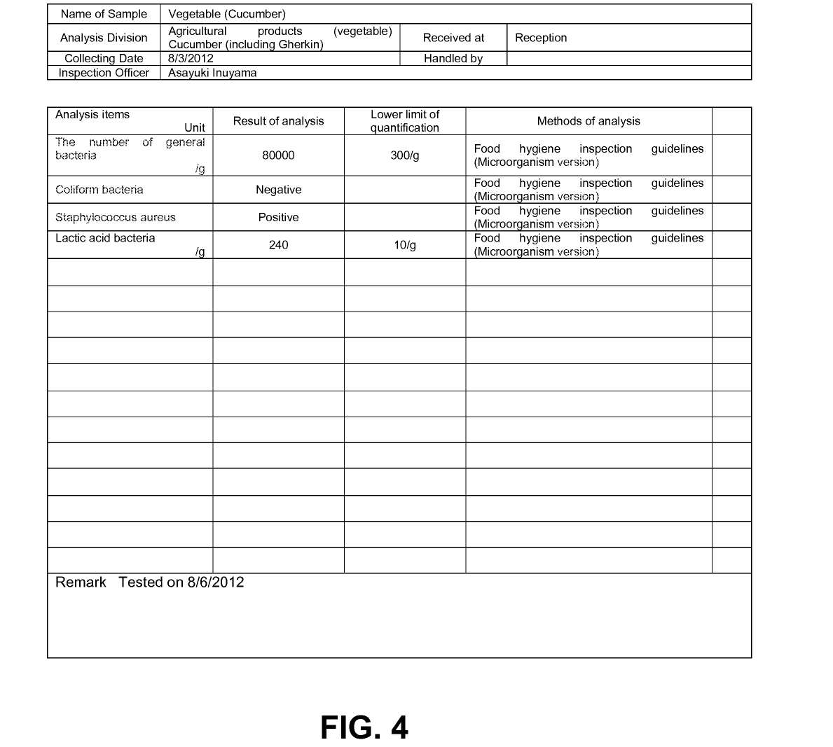

Furthermore, using the processed fish, cucumber was grown. As shown in FIG. 4, the cucumber contained 240 pieces/g of lactic acid bacteria. Therefore, it was confirmed that the processed fish can be used as a fertilizer to produce vegetables containing lactic acid.

Here, the fish carcass contained 370 pieces/g of lactic acid bacteria as a whole in average, but the content of lactic acid bacteria varied among parts. More specifically, the head contained 510 pieces/g, the skin contained 170,000 pieces/g, the collars contained 23,000 pieces/g, the bones contained 1,000 pieces/g, and the scales, the fins, and the guts contained lactic acid bacteria in an amount of not greater than 300 pieces/g. Therefore, selecting the parts to use, such as using only the skin or using the skin in combination with the collars, it is possible to make the processed fish and the livestock feed produced therefrom contain lactic acid bacteria in a large amount.

As described above, according to the present invention, the fish carcass left after carving fish meat is salted and left to stand in the state for a certain time period. Then, under natural environment, where temperature repeatedly changes, the fish carcass with salt kept adhered are hanged or placed on a net, avoiding direct sunlight, and are left to stand for a certain time period. As a result, the processed fish is made and then can be used to produce a fertilizer or s livestock feed, which contains the processed fish.

As a result, it is possible to keep the fertilizer contents such as nitrogen, phosphor, and potassium and/or feed contents such as unsaturated fatty acids therein in a large amount. In addition, it is possible to effectively use the fish carcass, which is conventionally wasted, as processed fish, a fertilizer, or a livestock feed.

Furthermore, according to the present invention, it is possible to produce processed food by processing poisonous guts of globefish to eliminate the toxicity thereof and serve them for eating.

More specifically, according to the present invention, guts are removed from globefish, and then salted. The salted guts are left to stand for a certain time period. Then, under natural environment, where temperature repeatedly changes, the guts are hanged or placed on a net, while avoiding direct sunlight and keeping the salt thereon. As a result, the guts can be served for eating as processed food.

Such globefish having poisonous guts includes, for example, tiger puffer (Takifugu rubripes), grass puffer (Takifugu niphoble), brown-backed toadfish (Laocephalus wheeleri), or the like. Guts are first removed from the globefish as is fresh without freezing (guts removal step).

Then, the guts removed from globefish in the guts removal step are placed in powdered salt to have their surfaces coated with the salt (salt coating step). Here, the salt may not be applied only on the guts surfaces, but also may be applied to fill inside the guts.

Thereafter, while being in such salted state as in the salting step, the guts are left to stand for a certain time period, at least one day or about one week (preferably one week) (salting step).

As a result of salting the surfaces of the globefish' guts, it is possible to satisfactorily sterilize the guts and prevent bacterial growth.

Thereafter, the salted internal organs of globefish obtained in the salting step are hanged or placed on a net under natural environment where temperature repeatedly changes, for example, in a mountain where naturally woods grow and there is no direct sunlight at all, and are left to stand for a certain time period, at least one week or about one month (preferably one month) (drying step).

Here, in the drying step, the internal organs of globefish having salt adhered thereon are wrapped with a water-permeable sheet, such as fabric, having finer mesh size than particle sizes of the powdered salt.

Then, the guts are left to stand for a certain time period so as to be subjected to repeated temperature changes, for example, at least one month or about one year (preferably one year) (natural aging step). In this step, the guts are also hanged or placed on a net in dark place where there is no direct sunlight at all. Here, this natural aging step will be repeated until the toxicity of the guts is eliminated.

Accordingly, hanging the internal organs of globefish to leave to stand while keeping the salt on their surfaces, it is possible to satisfactorily have water and oil inside the internal organs of globefish drip (discharge) therefrom. In addition, leaving the guts in the natural environment where temperature repeatedly changes for a period so as to be subjected to temperature changes, lactic acid bacteria having resistance against salt can grow by the temperature changes. Therefore, the resultant processed fish can contain lactic acid bacteria. Especially, when the internal organs of globefish are wrapped with a sheet having water permeability, it is possible to prevent salt coming off from the guts' surfaces, and also prevent nutrients (nitrogen, phosphor, potassium, unsaturated fatty acid, lactic acid, and so on) from dripping (discharging) therefrom with water and oil contents. Here, if a reservoir is placed to hold the water and oil dripped from the internal organs of globefish hanged right thereabove, it is possible to prevent bacteria growth and pest contamination by evaporation of the oil and surrounding the guts with the evaporated oil.

Thereafter, the produced processed food does not contain the toxicity and can be served as is for eating.

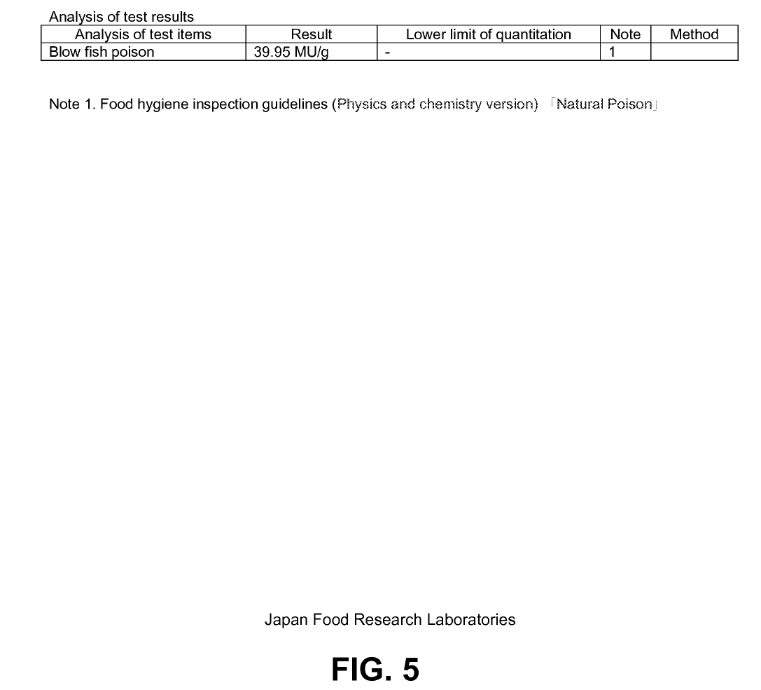

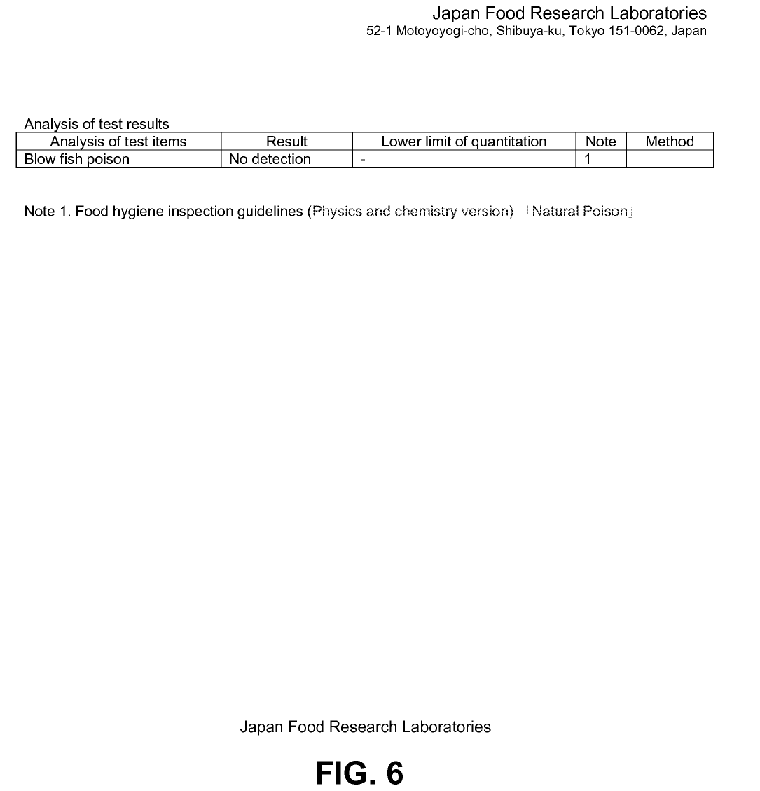

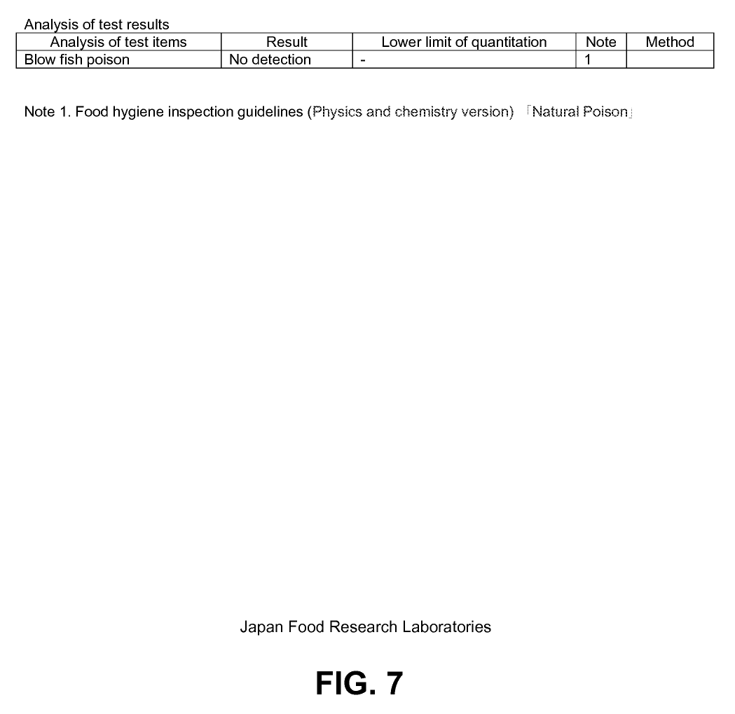

As an example, analytical test was conducted on processed food, which was subjected to one week of the salting step and one year of the natural aging step. As a result, as shown in FIG. 5, when the guts of grass puffer were processed by adhering Japanese mugwort thereon, the toxin of the grass puffer was detected. On the other hand, however, the toxin of the globefish was not detected from the grass puffer in FIG. 6 and also was not detected from the brown-backed toadfish as shown in FIG. 7.

As can be understood from the results, the toxin of the globefish that was covered with the Japanese mugwort was not eliminated from the guts and was detected. However, the toxin of the processed internal organs of globefish was processed together with the guts and was not detected thereafter. Therefore, the guts processed according to the present invention can be served to eat.

As described above, according to the present invention, the poisonous guts of globefish are salted and left to stand as is for a certain time period, and then hanged or placed on a net in natural environment so as to be subjected to repeated temperature changes, while avoiding exposure to direct sunlight and keeping the salt on the surfaces.

The processed guts obtained this way did not exhibit the globefish's toxicity and can be served for eating. Therefore, according to the present invention, it is achievable to effectively use internal organs of globefish, which are conventionally wasted, as a raw material of processed food.

The disclosures of Japanese Patent Applications No. 2012-236318, filed on Oct. 26, 2012, and No. 2012-282144, filed on Dec. 26, 2012, are incorporated in the application by reference.

While the present invention has been explained with reference to the specific embodiments of the present invention, the explanation is illustrative and the present invention is limited only by the appended claims.

What is claimed is:

1. A fish processing method, comprising:
a salting step of putting salt on fish parts on a plate and leaving the fish parts with salt on the plate; and
a drying step of hanging or placing the fish parts with salt on a net without exposing directly to sunlight and placing the fish parts so that oil is dripped from the fish parts with salt and evaporates right below the fish parts to surround the fish parts.

2. The fish processing method according to claim 1, wherein a fish carcass is obtained as the fish parts to be processed through carving a meat from a fish,
after the drying step, said fish carcass is wrapped with an air-permeable sheet and left to stand, and
said fish carcass is processed to produce a fertilizer containing nitrogen, phosphor, and potassium.

3. The fish processing method according to claim 1, wherein a fish carcass is obtained as the fish parts to be processed through carving a meat from a fish,
after the drying step, said fish carcass is placed on a non-air-permeable tray and left to stand, and
said fish carcass is processed to produce a fertilizer containing an unsaturated fatty acid.

4. The fish processing method according to claim 1, wherein internal organs of globefish are used as the fish parts to be processed, and
in the drying step, the internal organs of globefish are placed in a dark place where there is no direct sunlight at all so as to eliminate toxicity of globefish.
